(19) United States
(12) Patent Application Publication
(10) Pub. No.: US 2006/0010409 A1
(43) Pub. Date: Jan. 12, 2006

(54) Semiconductor integrated circuit design method, design support system for the same, and delay library

(75) Inventors: Yasuhiro Tamaki, Kyoto (JP); Kyoji Yamashita, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/101,466

(22) Filed: Apr. 8, 2005

(30) Foreign Application Priority Data
Jul. 7, 2004 (JP) 2004-200058

(51) Int. Cl. G06F 17/50

(52) U.S. Cl. 716/6; 716/4; 703/19

(57) ABSTRACT

In a semiconductor integrated circuit design method for simulating a delay of a logic circuit based on delay values which are calculated for each kind of a plurality of cells composing the logic circuit or for each signal path of the logic circuit and which are stored in a delay library, the simulation is performed to a block including at least one cell, and a delay value varying dependent on a layout direction of the cell included in the block is used as the delay value in the delay library. By this method, timing verification can be performed according to the layout direction of each cell layouted on a wafer, attaining precise margin of the design and improving yield of the semiconductor integrated circuit.

### CROSS REFERENCE TO RELATED APPLICATIONS

This Non-provisional application claims priority under 35 U.S.C. § 119(a) on Patent Application No. 2004-200058 filed in Japan on Jul. 7, 2004, the entire contents of which are hereby incorporated by reference.

### BACKGROUND ART

The present invention relates to a semiconductor integrated circuit design method for calculating by simulating a delay of a signal that propagates in a logic circuit in designing a large scale integrated circuit (LSI) including a MIS transistor, a design support system therefor, and a delay library.

Recently, miniaturization of patterns (circuit patterns) in semiconductor devices are being promoted at a feverish pace for increasing integration and enhancing performance of LSIs including MOS transistors. In association with the pattern miniaturization, patterns are formed at around the critical level of a logical resolution in a lithography step, and therefore, optical proximity effect and lens aberration in reduction projection exposure apparatuses greatly influence the patterns.

As a method of correcting the influence of the optical proximity effect, there has been proposed an optical proximity correction (OPC) method, however, mere process technology cannot eliminate the influence thoroughly. The lens aberration is liable to show different inherent tendencies (variation) in different reduction projection exposure apparatuses. This factor and miniaturization increase variation among devices, causing it difficult to precisely calculate path delays including the variation among LSIs in pre-stage of the LSI design.

In order to tackle this problem, there has been proposed one method in which a unit exposure region is divided into a plurality of regions and a delay library is provided which has variability information on variation in each divided region (see Japanese Patent Application Laid Open Publication No. 2003-196341A, for example).

FIG. 11 is a flowchart depicting a processing flow of a delay simulation method as a conventional semiconductor integrated circuit design method. Giving schematic explanation, as shown in FIG. 11, layout data of a semiconductor integrated circuit is read and a layout parameter is extracted from the read layout data (LPE: Layout Parameter Extraction) first in a step ST101. Specifically, a device parameter indicating element dimensions is extracted from mask data. Further, a net list serving as circuit interconnection information is created from the layout data.

Next, in a step ST102, a net along a signal path of which delay is to be obtained is extracted from the thus created net list and net data along the path is created.

Then, a delay library having variability information on variation in each divided region into which a unit exposure region is divided is referenced for the net data along the path in a step ST103, and a delay of the net along the path is calculated in a step ST104. This delay calculation of a net along a path is performed to every path in a semiconductor integrated to be simulated.

### SUMMARY OF THE INVENTION

However, the present inventors have carried out wide variety of examinations to find that: in recent years when progressive miniaturization is developed accompanying lens aberration in reduction projection exposure apparatuses, the conventional semiconductor integrated circuit design methods even using a delay library having variability information on variation in each of the plural divided regions into which the unit exposure region is divided invites difference in path delay according to a direction (layout direction) in which a cell as a minimum layout unit composing an LSI is layouted. One example of inviting the difference is shown in FIG. 12A to FIG. 12C. FIG. 12A indicates saturation drain currents (Idₛₐₜ) obtained by measuring circuits in which two layouts are arranged alternately in a transverse direction, one of the layouts being such that a PMOS is located on the upper side in the drawing as in a first inverter circuit shown in FIG. 12B while the other layout being such that a NMOS is located on the upper side in the drawing as in a second inverter circuit shown in FIG. 12C. FIG. 12A indicates results obtained from three kinds of inverter circuits whose gate widths are 0.32 μm, 0.64 μm, and 1.28 μm, and reference A denotes a group of the first inverter circuits with the gate width of 0.32 μm in which PMOSs are located on the upper side and B denotes a group of the second inverters with the gate width of 0.32 μm in which NMOSs are located on the upper side. As can be understood from FIG. 12A, values of each saturation drain current in the first inverter circuit group is higher than those in the second inverter circuit group.

As explained above, in the phenomenon that the operation characteristic of a device depends on the cell layout direction, a variation amount in path delay caused according to the cell layout direction is different among the kinds of cells and is also different among reduction projection exposure apparatuses. Further, even if the same type of reduction projection exposure apparatuses are used, the variation amount is different apparatus by apparatus (lot by lot).

A method of controlling the lens aberration can be considered as a method for solving the problem of the phenomenon that the device characteristic depends on the cell layout direction through a process approach, but it is extremely difficult to control the lens aberration. A method of correcting, by OPC, dimensional shift of the MOS transistor caused due to lens aberration may be considered as another method. However, this method necessitates a photomask for each reduction projection exposure apparatus, which is impractical.

The present invention has its object of solving the aforementioned conventional problems and attaining precise margin of the design in operation timing by introducing into timing verification in design the phenomenon caused due to lens aberration that the device characteristic and the path delay vary according to the cell layout direction.

In order to attain the above object, the present invention has a constitution in which delay values dependent on the layout directions of cells is used as delay values of cells registered in a delay library in a semiconductor integrated circuit design method.

Specifically, a first semiconductor integrated circuit design method according to the present invention is directed to a semiconductor integrated circuit design method in which a delay of a logic circuit is simulated based on a delay value in a delay library that stores delay values including the delay value which are calculated on a per kind basis of a plurality of cells composing the logic circuit or on a per signal path basis of the logic circuit, wherein the simulation is performed to a block including at least one of the cells, and a delay value varying dependent on a layout direction of the cell included in the block is used as the delay value in the delay library.

The first semiconductor integrated circuit design circuit enables timing verification of the cell layouted within the block according to the layout direction thereof, involving no influence of the cell layout direction to enable precise margin of the design. Thus, the yield of the semiconductor integrated circuit is increased.

In the first semiconductor integrated circuit, it is preferable to use a delay value of a delay caused in the block due to a physical factor in exposure within a unit exposure region of the block in a case where the block is formed on a wafer as the delay value varying dependent on the layout direction of the cell.

Also, in the first semiconductor integrated circuit design method, the delay library preferably includes a delay value dependent on an exposure apparatus used for exposure. This enables the delay value dependent on the exposure apparatus to be taken into consideration in the simulation, eliminating dependency of the delay value on the exposure apparatus, that is, variation among exposure apparatuses.

A second semiconductor integrated circuit design method according to the present invention includes the steps: creating a delay library that introduces, into delay values calculated for each kind of a plurality of cells composing a logic circuit or for each signal path of the logic signal, delay values varying dependent on layout directions of the cells; creating a net list by extracting a layout parameter from layout data of a semiconductor integrated circuit using the logic circuit; extracting a net along one signal path from the thus created net list; detecting a layout direction of a cell included in the extracted net; and calculating a delay value of the cell of which layout direction is detected by referencing a delay value in the delay library which corresponds to that of the cell of which layout direction is detected.

In the second semiconductor integrated circuit design method, the delay library that introduces the delay value varying according to the cell layout direction is created, and then, the delay value of the cell of which layout direction is detected is calculated by referencing a delay value corresponding to the detected cell layout direction in the delay library. Accordingly, timing verification can be performed according to the layout direction of each cell layouted on a wafer without involving influence of the cell layout direction. As a result, precise margin of the design is attained to increase the yield of the semiconductor integrated circuit.

A first semiconductor integrated circuit design support system according to the present invention is directed to a system for simulating a delay of a logic circuit based on delay values which are stored in a delay library and which are calculated for each kind of a plurality of cells composing the logic circuit or for each signal path of the logic circuit, and includes: a first memory section which reads from the delay library and holds a delay value that introduces a variation amount varying dependent on each layout direction of the cells; and a second memory section which performs simulation to a block including at least one of the cells, a semiconductor chip region that includes a plurality of blocks each including at least one of the cells, and a unit exposure region that includes a plurality of semiconductor chip regions each including at least one of the blocks, wherein in layout information of the cells, layout directions of the cells are relayed from the blocks to the semiconductor chip regions and from the semiconductor chip regions to the unit exposure region in hierarchic transition.

In the first semiconductor integrated circuit design support system, the delay value introducing the variation amount that varies dependent on the layout direction per cell is read from the delay library, and simulation is performed to the block including at least one of the cells, the semiconductor chip region that includes a plurality of blocks each including at least one of the cells, and a unit exposure region that includes a plurality of semiconductor chip regions each including at least one of the blocks. In the simulation, the cell layout direction of the cell layout information is relayed in hierarchical transition from the block to the semiconductor chip region and from the semiconductor chip region to the unit exposure region. Hence, any cell layout direction in any hierarchic level can be detected, enabling precise margin of the design.

A second semiconductor integrated circuit design support system according to the present invention is directed to a system for simulating a delay of a logic circuit based on delay values which are stored in a delay library and which are calculated for each kind of a plurality of cells composing the logic circuit or for each signal path of the logic circuit, and includes: a first memory section which reads from the delay library and holds a delay value that introduces a variation amount varying dependent on each layout direction of the cells; and a second memory section which performs simulation to a block including at least one of the cells, a semiconductor chip region that includes a plurality of blocks each including at least one of the cells, and a unit exposure region that includes a plurality of semiconductor chip regions each including at least one of the blocks, wherein in a net list of the cells, layout directions of the cells are relayed from the blocks to the semiconductor chip regions and from the semiconductor chip regions to the unit exposure region in hierarchic transition.

In the second semiconductor integrated circuit design support system, the delay value introducing the variation amount that varies dependent on the layout direction per cell is read from the delay library, and simulation is performed to the block including at least one of the cells, the semiconductor chip region that includes a plurality of blocks each including one of the cells, and a unit exposure region that includes a plurality of the semiconductor chip regions each including one of the blocks. In the simulation, the cell layout direction of the cell layout information is relayed in the net list of the cells from the block to the semiconductor chip region and from the semiconductor chip region to the unit exposure region. Hence, any cell layout direction in any hierarchic level can be detected, enabling precise margin of the design.

In the first or second semiconductor integrated circuit design support system, the delay library preferably includes a delay value dependent on an exposure apparatus used for exposure.

A delay library according to the present invention is directed to a delay library in which delay values that are calculated for each kind of a plurality of cells composing a logic circuit or for each signal path of the logic circuit are stored and which is used in a semiconductor integrated circuit design support system for simulating a delay of the logic circuit, wherein the delay values are stored on a per layout direction basis of the cells and on a per exposure apparatus basis which is used for exposure.

In the delay library of the present invention, the delay values of the cells are stored on a per cell layout direction basis and on a per exposure apparatus basis which is used for exposure. Accordingly, delay simulation to a logic circuit using the delay library of the present invention enables timing verification according to each layout direction of the cells layouted on a waver. Hence, no influence of cell layout direction is involved, enabling precise margin of the design.

In the delay library according to the present invention, it is preferable that one of the plurality of cells is set as a representative cell, first delay values in each of a plurality of layout directions in each of a plurality of exposure apparatuses of the representative cell are calculated, and delay characteristic variation coefficients of the representative cell are determined from the calculated first delay values, a second delay value in one layout direction to be a standard in one exposure apparatus to be a standard is calculated for each of the cells, and the delay values are determined by multiplying the calculated second delay values by the delay characteristic variation coefficients. In this constitution, a representative cell is selected among the plurality of cells and layout angle dependency and exposure apparatus lot dependency of delay values on the other cells are calculated using the delay characteristic variation coefficient of the selected representative cell. Hence, the delay library of the present invention can be created with ease.

### BRIEF DESCRIPTION OF THE DRAWINGS

FIG. 1 is a block diagram illustrating a semiconductor integrated circuit design support system according to a first embodiment of the present invention.

FIG. 2 is a flowchart depicting a semiconductor integrated circuit design method according to the first embodiment of the present invention.

FIG. 3A to FIG. 3E refer to the semiconductor integrated circuit design method according to the first embodiment of the present invention, wherein FIG. 3A is a schematic plan view of an inverter cell; FIG. 3B is a schematic view of a block to be simulation in which a plurality of inverter cells are illustrated together with their layout directions; FIG. 3C is a schematic plan view of a semiconductor chip in which a plurality of blocks are illustrated together with their layout directions; FIG. 3D is a schematic plan view of a unit exposure region in which a plurality of semiconductor chips are illustrated together with their layout directions; and FIG. 3E is a schematic perspective view of a semiconductor wafer divided into a plurality of unit exposure regions.

FIG. 4A and FIG. 4B refer to the semiconductor integrated circuit design method according to the first embodiment of the present invention, wherein FIG. 4A is a drawing indicating one example of a net list having information on cell layout angles; and FIG. 4B is a circuit diagram indicating a net along one path.

FIG. 5 is a flowchart depicting a delay library creation method according to a second embodiment of the present invention.

FIG. 6 is a list indicating one example of the delay library according to the second embodiment of the present invention.

FIG. 7 is a flowchart depicting a delay library creation method according to a third embodiment of the present invention.

FIG. 8 shows the delay library creation method according to the third embodiment of the present invention and is a flowchart depicting processing for calculating a delay characteristic variation coefficient K based on an exposure apparatus lot and a cell layout angle.

FIG. 9 shows the delay library creation method according to the third embodiment and is a flowchart depicting processing for creating a standard delay library based on an exposure apparatus lot to be a standard and a cell layout angle to be a standard.

FIG. 10A, FIG. 10B, and FIG. 10C shows the delay library creation method according to the third embodiment of the present invention, wherein FIG. 10A indicates one example of the standard delay library; FIG. 10B indicates one example of the delay characteristic variation coefficient K; and FIG. 10C indicates one example of the delay library.

FIG. 11 is a flowchart depicting a conventional semiconductor integrated circuit design method.

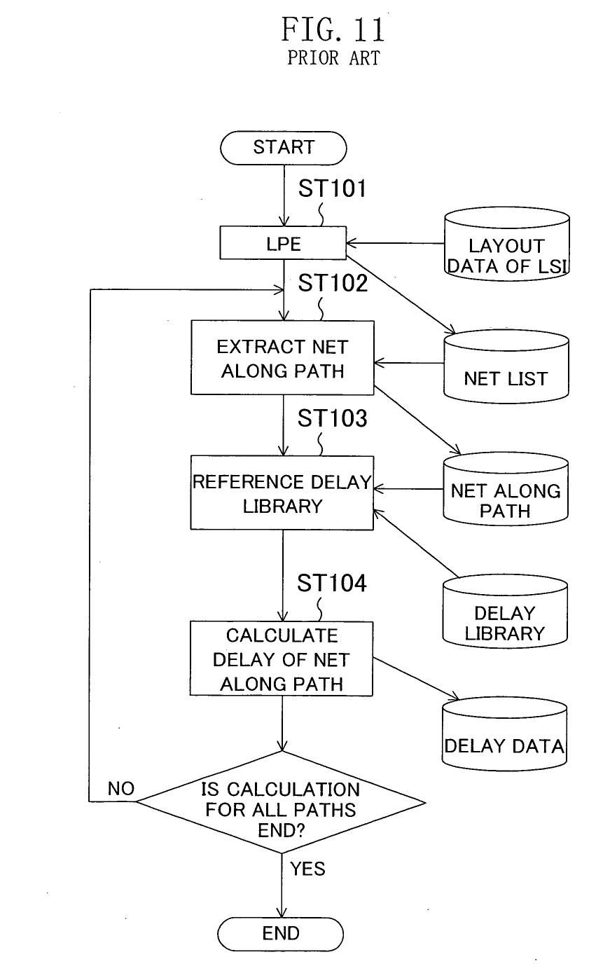

FIG. 12A, FIG. 12C, and FIG. 12C are drawing for explaining problems that the present invention is to solve, wherein FIG. 12A is a graph showing variation in saturation drain currents in the case where a plurality of inverter circuits are connected; and FIG. 12B and FIG. 12C are plan view for explaining the layout directions of the inverter circuits.

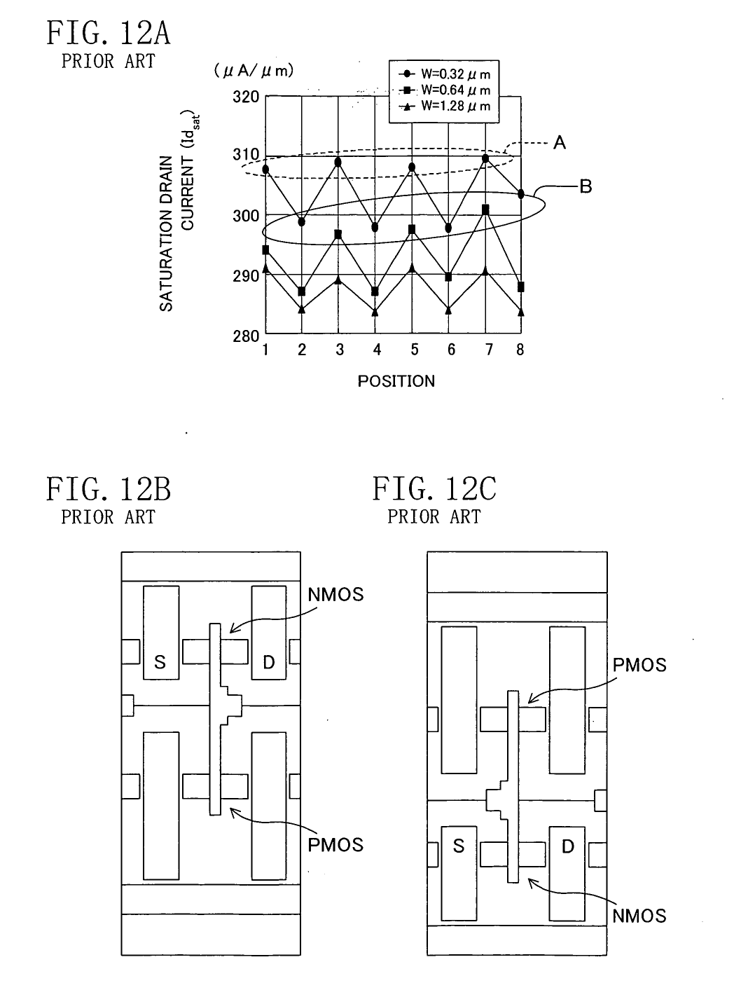

### DESCRIPTION OF THE PREFERRED EMBODIMENTS

### First Embodiment

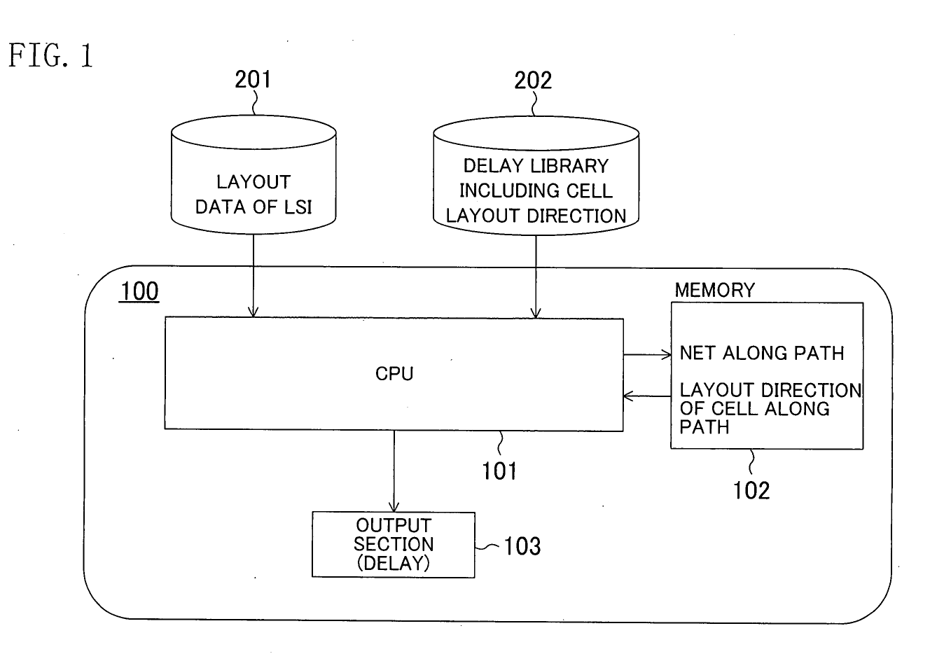

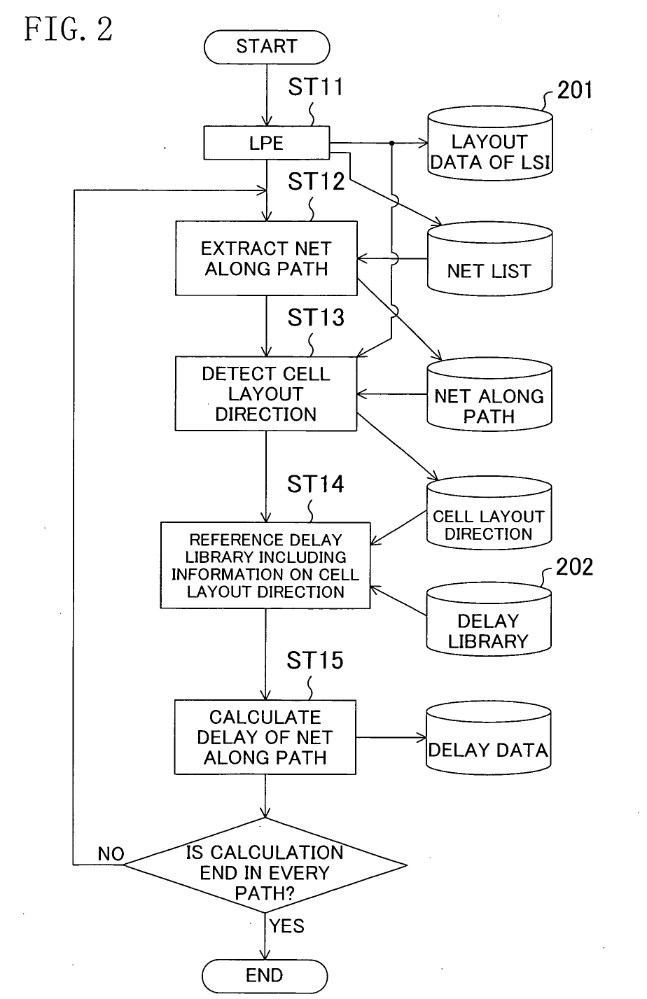

A first embodiment of the present invention will be descried with reference to the drawings. FIG. 1 shows a constitution in blocks of a semiconductor integrated circuit design support system according to the first embodiment of the present invention, and FIG. 2 shows a semiconductor integrated circuit design method using the design support system and depicts a flow for timing verification of a large scale semiconductor integrated circuit (LSI).

As shown in FIG. 1, the design support system 100 is a workstation, for example and is composed of a CPU 101, a main memory 102, and output section 103.

In delay calculation, layout data 201 of an LSI to be verified and a delay library 202 including each layout direction of cells of a cell group composing the LSI to be verified are read.

Operation of the semiconductor integrated circuit design support system constituted as above will be described below with reference to FIG. 2.

As shown in FIG. 2, the layout data 201 of the LSI is read and a layout parameter is extracted from the read layout data 201 (LPE: Layout Parameter Extraction) in a step ST11. Specifically, a device parameter indicating element dimensions is extracted from mask data. Further, a net list serving as circuit interconnection information is created from the layout data 201.

Next, in a step ST12, one of nets along a signal path of which delay is to be obtained is extracted from the thus generated net list to create net data along the path.

Subsequently, in a step ST13, each layout direction of cells composing the net along the path and formed on a wafer is detected from the layout data 201. Wherein, the cell layout direction detection method will be described later.

Then, while referencing the delay library 202 including delay information on a delay according to the cell layout direction to take account of variation in delay dependent on the cell layout direction in a step ST14, delay calculation of the net along the path is performed in the next step ST15. The delay calculation of a net along one path is performed to every other paths of the semiconductor integrated circuit to be simulated. This enables timing calculation in LSI scale which takes account of each layout direction of the cells layouted on the wafer.

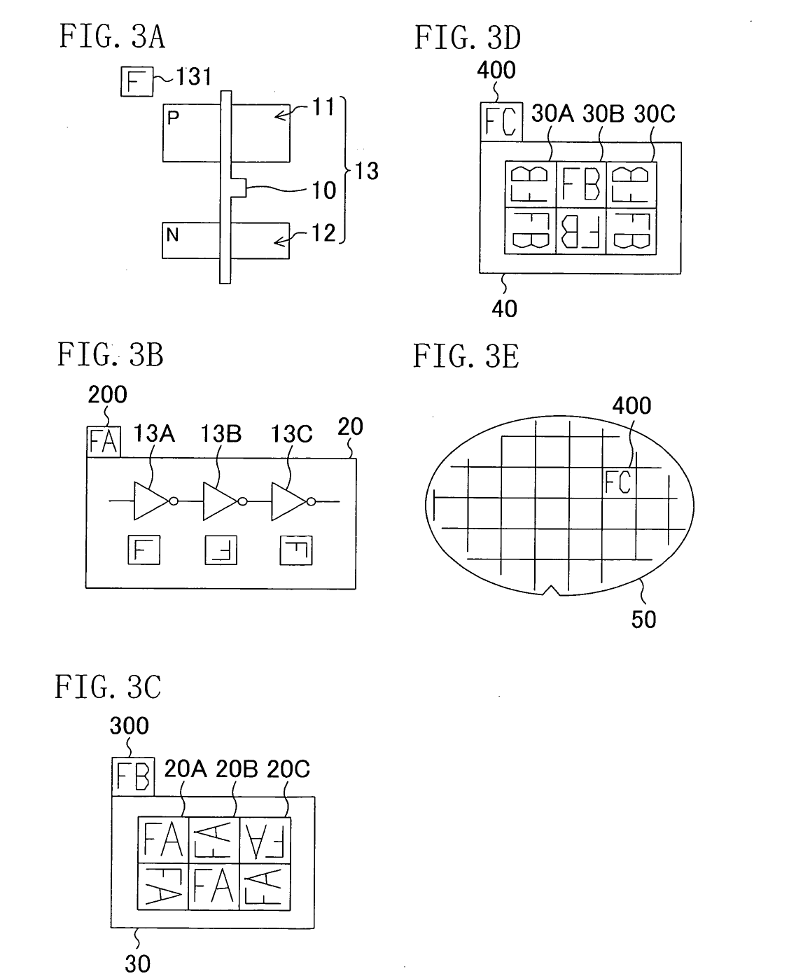

The cell layout direction detection method will be described below with reference to FIG. 3A to FIG. 3E.

FIG. 3A illustrates an inverter cell 13 composed of a PMOS 11 and a NMOS 12 which use a gate 10 in common, wherein a mark F accompanying reference numeral 131, which has neither line symmetry nor rotation symmetry, indicates that the inverter cell 13 layouted in this state forms an angle of 0 degree with respect to a reference line of a wafer.

FIG. 3B shows one example of a block 20 as the lowest hierarchical layer of a net along one path and is composed of a first inverter cell 13A, a second inverter cell 13B, and a third inverter cell 13C, wherein layout directions of the cells are set to be 0 degree, 180 degrees, and 90 degrees from the left to the right. Herein, a mark FA accompanying reference numeral 200 indicates that the layout direction of the block 20 forms an angle of 0 degree with respect to the reference line of the wafer.

FIG. 3C shows one example of a chip region composed of a first block 20A, a second block 20B, a third block 20C, and so on, of which layout directions are set to be 0 degree, 270 degrees, and 180 degrees, for example, from the left to the right in the upper row. Herein, a mark FB accompanying reference numeral 300 indicates that the layout direction of the chip region 30 forms an angle of 0 degree with respect to the reference line of the wafer.

Also, FIG. 3D shows one example of a unit exposure region (one-shot region) composed of a first chip region 30A, a second chip region 30B, a third chip region 30C, and so on, of which layout directions are set to be 270 degrees, 0 degree, and 270 degrees, for example, from the left to the right in the upper row. Herein, as shown in FIG. 3E, a mark FC accompanying reference numeral 400 indicates that the layout direction of the unit exposure region 40 forms an angle of 0 degree with respect to the reference line of the wafer.

As described above, information on each layout direction of the inverter cells 13 is held and added as the hierarchy goes upward from FIG. 3B to FIG. 3C and further to FIG. 3D, namely, from the net or block 20 to the chip region 30 and from the chip region 30 to the unit exposure region 40, thereby enabling detection of any cell layout direction even with any hierarchy level set as a standard. For example, the second block 20B is rotated 270 degrees in the chip region shown in FIG. 3C, and accordingly, the second inverter cell 13B in FIG. 3B, which is layouted with 180 degrees rotated, is rotated 45° degrees that is obtained by adding 180-degree rotation in the first hierarchic layer and 270-degre rotation in the second hierarchic layer, which means that the cell is layouted with 90 degrees rotated actually.

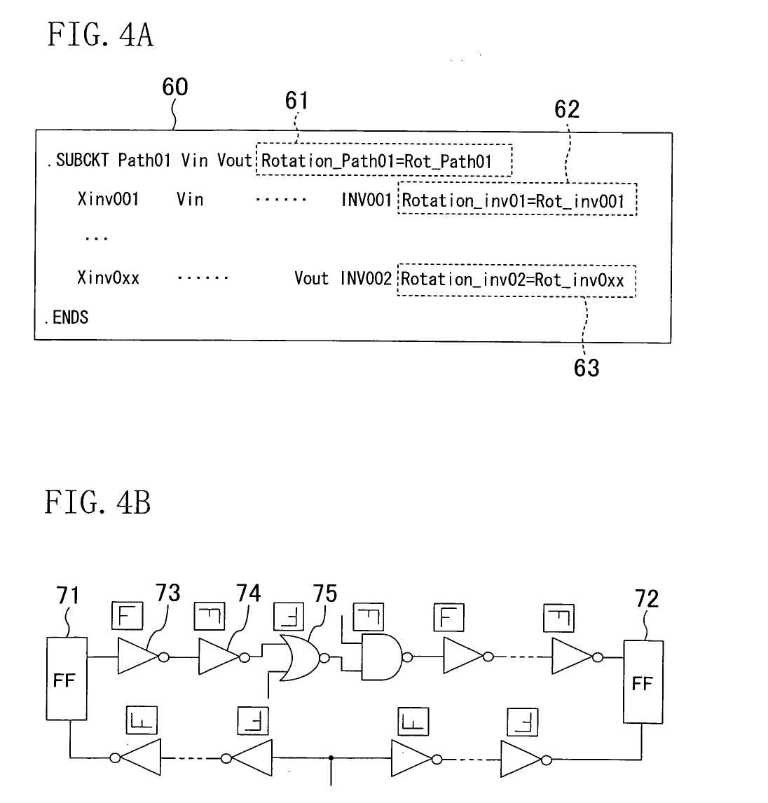

In a specific method of detecting a final cell layout direction by holding the cell layout direction even in the upper hierarchic levels of the net or the block, a net list 60 to which each cell layout direction (layout angle) is added as indicated in FIG. 4A is used. The net list 60 has a hierarchy in the form of a block and holds layout angle information indicating the layout direction of each cell. In the net list 60, a child block having layout angle information when viewed from a parent block is described in the parent block and the parent block also has layout angle information when viewed from a further upper hierarchic layer (reference numerals 61, 62, and 63).

It is noted that the left side of the reference numeral 61 presents, for example, a layout angle variation name indicating a block layout angle when viewed from the further upper hierarchic layer which is indicted in the net list 60 while the right side thereof indicates a variation value, that is, the block layout angle when viewed from the upper hierarchic layer which is indicated in the net list 60. Wherein, the layout angle indicated by the right side in the reference numeral 61 is effective only when a layout angle is not received from the block of the upper hierarchic layer. When the layout angle is relayed otherwise, the receive layout angle becomes effective.

For example, in a path delay circuit including a first inverter cell 73 of which layout angle is 0 degree, a second inverter cell 74 of which layout angle is 90 degrees, a NOR circuit 75 of which layout angle is 180 degrees, and the like between a first flip flop 71 and a second flip flop 72, when a net list having the aforementioned layout angle information is employed and a delay library including the cell layout direction information is referenced, delay taking account of delay variation according to the cell layout direction can be calculated.

It should be noted that the first embodiment of the present invention refers to a design evaluation method taking account of variation in delay caused due to possible lens aberration at exposure in a lithography step of a semiconductor manufacture process, but the present invention is applicable not only for detecting the cell layout directions but also for detecting dependency and the like on each of a plurality of exposure apparatuses, namely, on each exposure apparatus lot.

In consequence, in the first embodiment, variation in delay of a semiconductor integrated circuit (logic circuit) can be calculated for each cell layout direction and for each exposure apparatus lot. Hence, selection and use of a lot of an exposure apparatus according to the kinds of cells in a semiconductor device manufacture process enables margin of the design in operation timing to be minimized, attaining precise margin of the design.

### Second Embodiment

A second embodiment of the present invention will be described below with reference to the drawings.

In the second embodiment, a method for creating a delay library having delay data of each cell layout direction and of each lot of exposure apparatuses will be described.

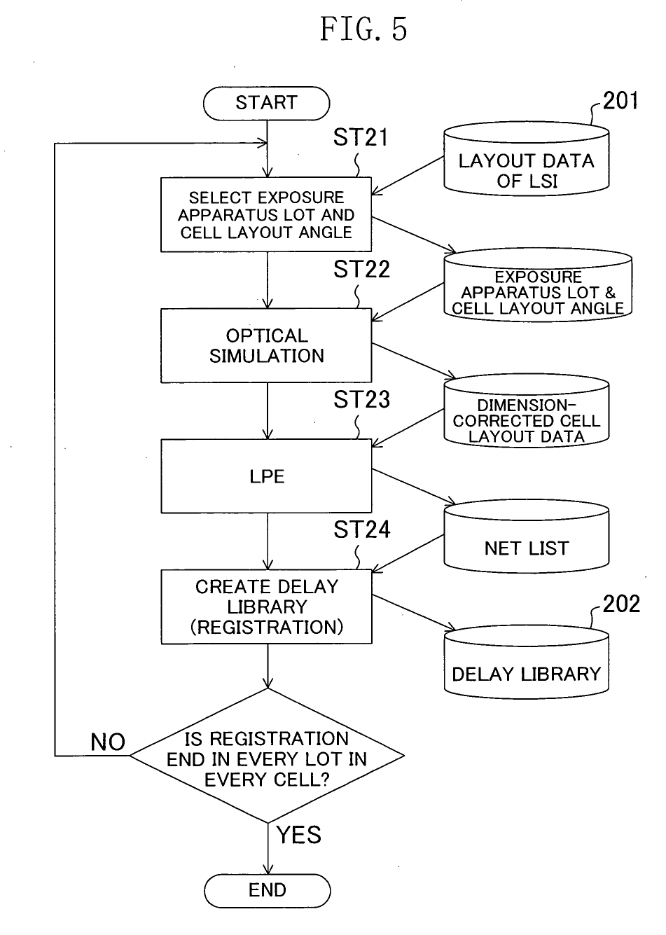

FIG. 5 depicts a processing flow of a delay library creation method that introduces delay variation dependent on the exposure apparatus lots and on the cell layout directions according to the second embodiment of the present invention. In detail, FIG. 5 shows a sequence for calculating a delay in cell level between a gate length of a MOS transistor at a design stage in the layout data 201 including a cell as a minimum layout unit of an LSI to be simulated and a gate length subjected to the semiconductor device process.

As shown in FIG. 5, a lot of an exposure apparatus to be used for exposure and a cell layout angle are first selected by referencing the layout data 201 of the LSI in a step ST21. The step herein is performed merely for selecting a condition for optical simulation to be performed later, and the order for selecting the exposure apparatus lot and the cell layout direction are not limited especially.

Next, in a step ST22, the optical simulation of a gate length of a MOS transistor out of the layout data subjected to optical proximity correction (OPC) processing is performed, with the use of the selected exposure apparatus lot and the selected cell layout angle as an input parameter for the simulation condition. Whereby, layout data in which dimensions are corrected so as to render a gate length after lithography and etching steps is created.

Subsequently, in a step ST23, layout parameter extraction (LPE) is performed for extracting a device parameter indicating element dimensions from the dimension-corrected layout data to create a net list that introduces the gate length subjected to the optical simulation serving as circuit interconnection information.

Then, in a step ST24, simulation of the created net list is performed using SPICE (Simulation Program with Integrated Circuit Emphasis) to create a delay library.

Repetition of the above series of processing for each exposure apparatus lot and for each cell layout angle creates a delay library 202 that introduces variation in delay dependent on the exposure apparatus lot and the cell layout angle.

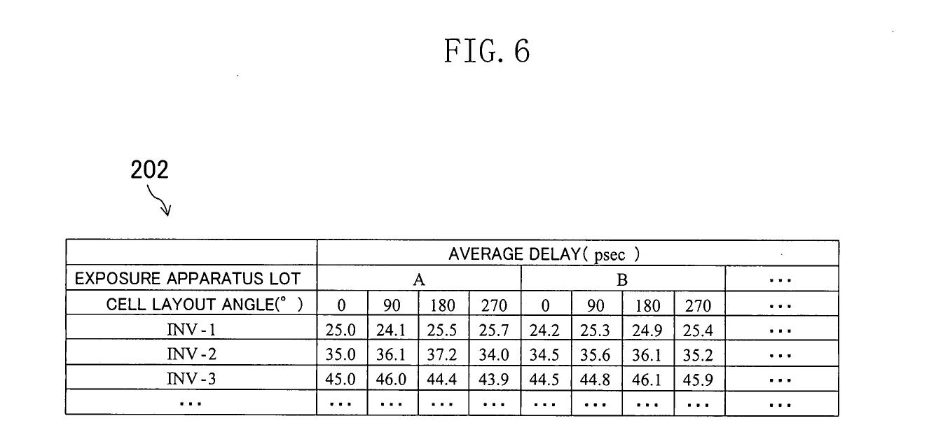

FIG. 6 indicates one example of library data in the delay library 202. FIG. 6 lists average values of delays of inverter cells INV-1, INV-2, INV-3 and so on in a lot A and a lot B of exposure apparatuses and in each cell layout angle of 0 degree, 90 degrees, 180 degrees, and 270 degrees.

As can be understood, the delay library 202 according to the second embodiment is created so as to hold each delay value of the cells, which are each a layout minimum unit, on a par cell layout direction basis and on a per exposure apparatus basis which is used for exposure, enabling timing verification according to each layout direction of each cell layouted on a wafer in each exposure apparatus. As a result, no influence of the cell layout direction is involved, attaining precise margin of the design.

It is to be noted that the optical simulation in the step ST22 in the second embodiment may be performed using measured (actual measurement) data of the gate length after gate formation in the MOS transistor manufacture process.

### Third Embodiment

A third embodiment of the present invention will be described below with reference to the drawings.

In the third embodiment, another method for creating a delay library having delay data of each cell layout direction and of each exposure apparatus lot will be described.

In the second embodiment, the delay library 202 is created from the net list created by optical simulation and LPE to all cell data of the layout data 201 of the LSI. While in the third embodiment, a representative cell is selected from the layout data 201, each delay characteristic variation coefficient of each exposure apparatus lot and of each cell layout angle in the selected representative cell is obtained, and then, the delay characteristic variation coefficients are multiplied to the other cells, thereby obtaining delay values dependent on every exposure apparatus lot and on every cell layout angle.

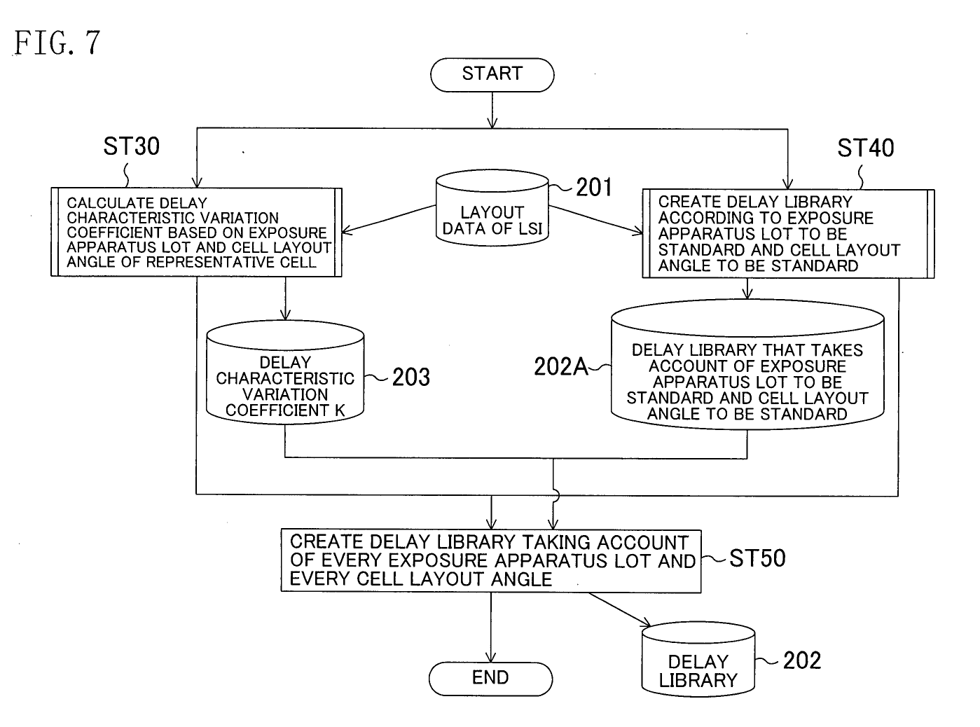

FIG. 7 is a flowchart depicting a method for creating a delay library introducing variation dependent on the exposure apparatus lot and the cell layout direction (layout angle) according to the third embodiment of the present invention.

As shown in FIG. 7, in the delay library creation method according to the third embodiment, one representative cell is selected from the layout data 201 including cells each serving as a minimum layout unit of an LSI to be simulated and delay characteristic variation coefficients K (203) respectively based on the exposure apparatus lots and the cell layout angles of the selected representative cell are calculated first in a step ST30.

Next, in a step ST40, an exposure apparatus lot to be a standard and a cell layout angel to be a standard are selected from the layout data 201 and a delay library 202A of each cell is created according to the selected exposure apparatus lot and the selected cell layout angle. It is noted that the processing order of the steps ST30 and ST40 is not limited.

Herein, the representative cell is one of a plurality of cells, and is the inverter cell INV-1 in FIG. 6, for example. The exposure apparatus lot to be a standard is the lot A of the exposure apparatus in FIG. 6, for example, and the cell layout angle to be a standard is a cell angel of 0 degree in FIG. 6, for example.

Subsequently, in a step ST50, delay data based on the exposure apparatus lot to be a standard and the cell layout angle to be a standard is multiplied by the delay characteristic variation coefficients K to create the delay library 202.

The step ST30 and the step ST40 will be described below in detail.

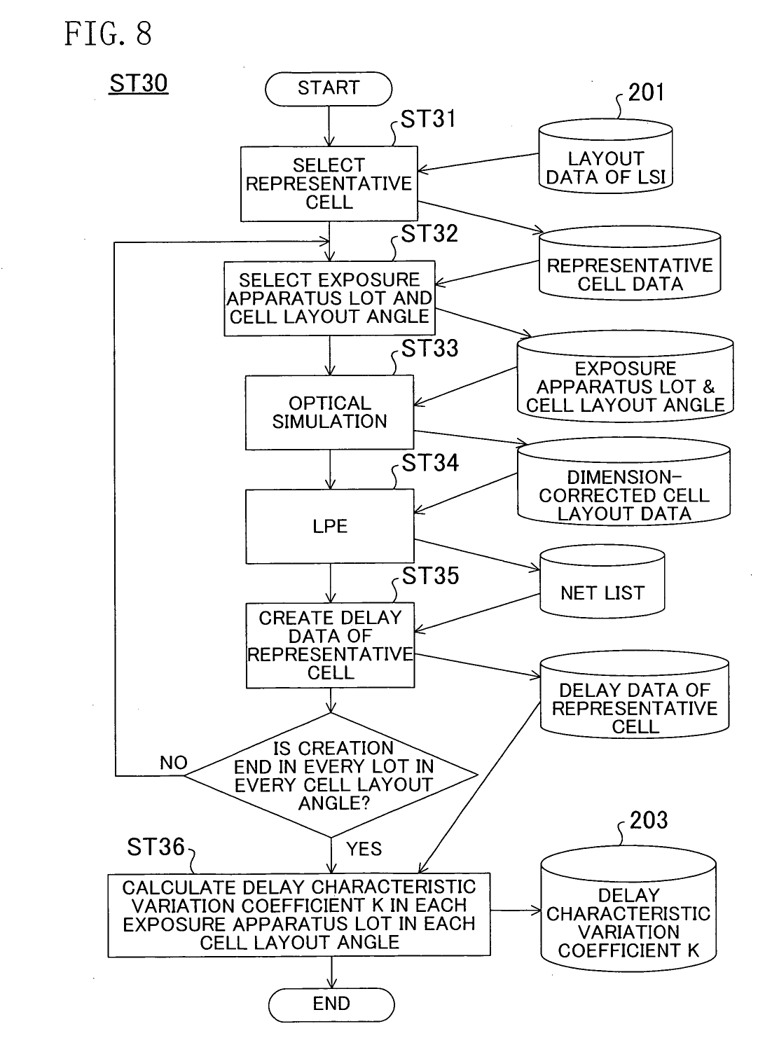

FIG. 8 depicts a flowchart of the step ST30 for calculating the delay characteristic variation coefficients K based on the exposure apparatus lots and the cell layout angles according to the third embodiment.

As shown in FIG. 8, one representative cell is selected from the layout data 201 first in a step ST31. Herein, the inverter cell INV-1 shown in FIG. 6 is used as the representative cell, for example. The result of delay simulation to the representative cell directly affects delays according to the layout directions in all the cells, and therefore, the representative cell must be selected carefully. Referring to a criterion for the selection, when a cell having the highest use frequency in the layout data 201 is selected, for example, accuracy of delay calculation of each path can be increased averagely over a whole LSI. Alternatively, for increasing the accuracy of the delay calculation of a critical path, a cell to which a signal propagates through the critical path is selected from the layout data 201, for example. It is noted that a plurality of cells may selected as representative cells.

Then, in a step ST32, one of lots is selected from a plurality of exposure apparatus lots, one of a plurality of mirrors is selected, and further, one of a plurality of layout angles is selected.

Next, in a step ST33, optical simulation of a gate length of a MOS transistor in the layout data subjected to optical proximity correction (OPC) is performed to the representative cell, using the selected exposure apparatus lot and the selected layout angle as an input parameter for a simulation condition. Thus, layout data in which dimensions are corrected so as to render a gate length after lithography and etching steps is created.

Subsequently, in a step ST34, a layout parameter extraction (LPE) is performed for extracting a device parameter indicating element dimensions from the dimension-corrected layout data to create a net list serving as circuit interconnection information which introduces the gate length obtained by the optical simulation.

Then, in a step ST35, delay data of the representative cell is created from the thus created net list. The above series of processing is repeated in each exposure apparatus lot in each layout angle of the representative cell.

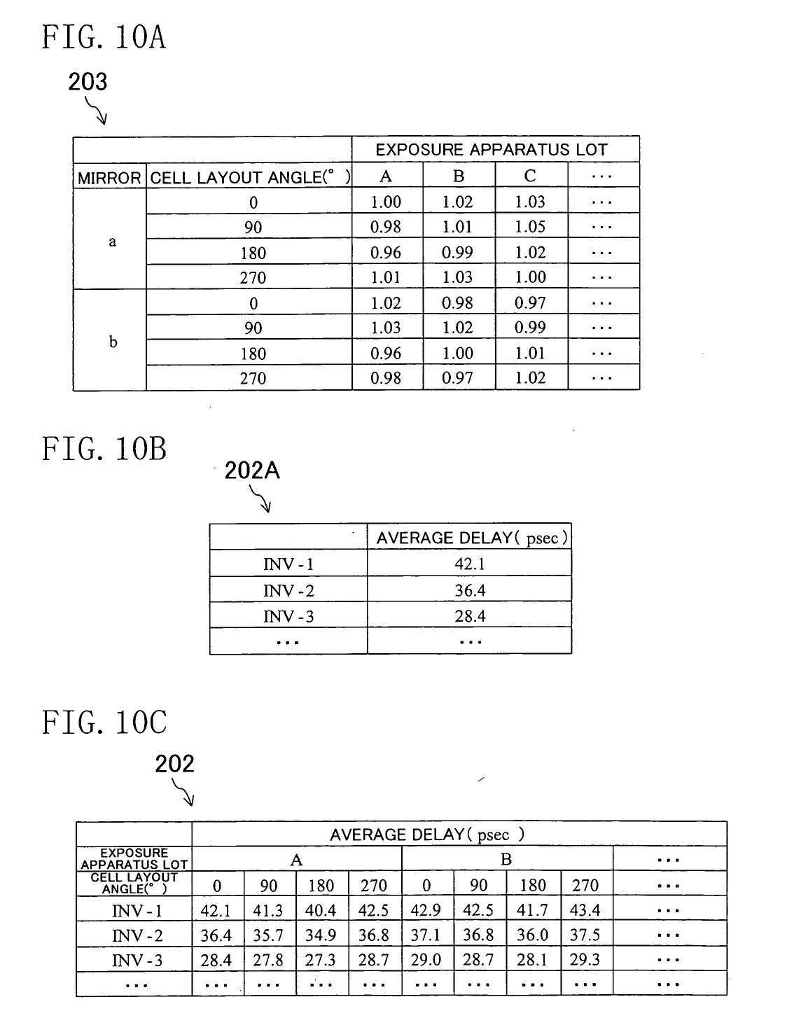

Next, in a step ST36, data 203 of the delay characteristic variation coefficients K is formed on each per basis of the kinds of mirrors, the cell layout angles, and the exposure apparatus lots in the form of a table, for example, as shown in FIG. 10A. Herein, a standard value of the delay characteristic variation coefficients K is set to be 1.00 under the conditions that the cell layout angle is 0 degree, the mirror is a, and the exposure apparatus lot is A.

The step ST40 will be described next.

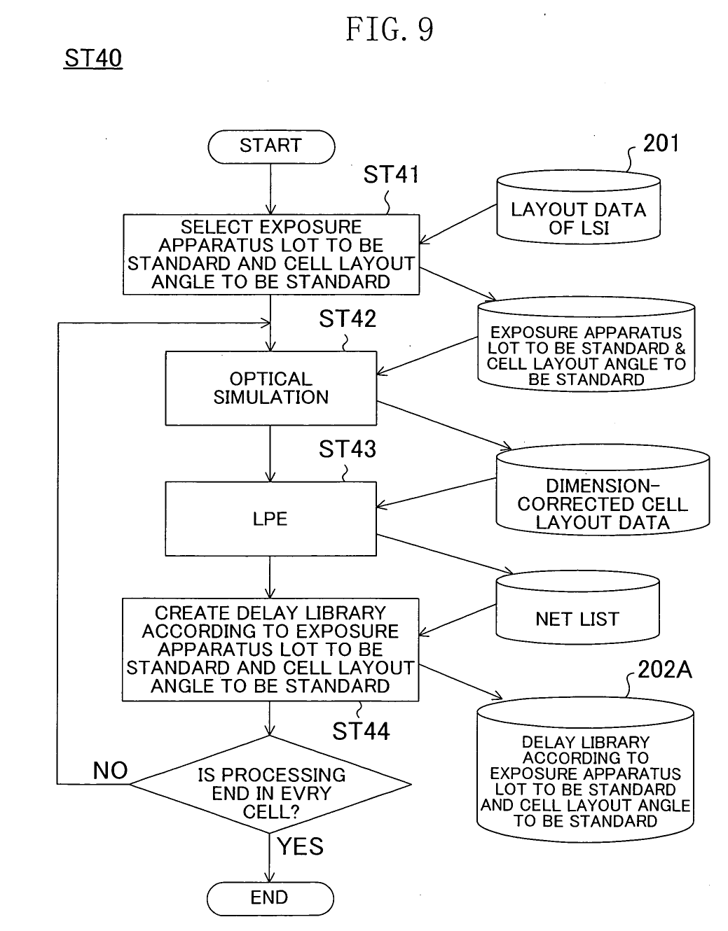

FIG. 9 shows a flowchart of the step ST40 for creating the delay library 202A to be a standard based on the exposure apparatus lot to be a standard and the layout angel to be a standard according to the third embodiment of the present invention.

As shown in FIG. 9, in a step ST41, a lot of an exposure apparatus used for exposure to be a standard and a layout angle to be a standard are selected first by referencing the layout data 201 of the LSI. Herein, a condition for the optical simulation to be performed later is selected merely, and the order of selecting the exposure apparatus lot and the cell layout angle is not limited especially.

Next, in a step ST42, the optical simulation of a gate length of a MOS transistor in the layout data subjected to optical proximity correction (OPC) is performed using the selected exposure apparatus lot and the selected cell layout angle as an input parameter of the simulation condition. Whereby, layout data in which dimensions are corrected so as to render a gate length after the lithography step is created.

Subsequently, in a step ST43, layout parameter extraction (LPE) for extracting a device parameter indicating element dimensions from the dimension-corrected layout data is performed to create a net list serving as circuit interconnection information which introduces the gate length obtained by the optical simulation.

Subsequently, in a step ST44, simulation is performed using SPICE to calculate delay data according to the lot to be a standard and according to the cell layout angle to be a standard from the created net list. The above series of processing is repeated in each cell to create a standard delay library 202A indicated in FIG. 10B, for example.

Then, delay data in the standard delay library 202A created in the step ST44 is multiplied by the delay characteristic variation coefficients K calculated in the step ST36 to obtain the delay library 202 that takes every exposure apparatus lot and every cell layout angle into consideration, as indicated in FIG. 10C.

As described above, in the semiconductor integrated circuit design method, the design support system therefor, and the delay library according to the present invention, timing verification can be performed according to each layout direction of the cells layouted on a wafer, involving no influence of the cell layout direction. As a result, precise margin of the design can be attained and the yield of semiconductor integrated circuit manufacture can be increased. Thus, they are useful as a semiconductor integrated circuit design method and the like for calculating a delay of a signal that propagates in a logic circuit by simulation in designing a large scale integrated circuit including a MIS transistor.

What is claimed is:

1. A semiconductor integrated circuit design method comprising the step of:
simulating a delay of a logic circuit based on a delay value in a delay library that stores delay values including the delay value which are calculated for each kind of a plurality of cells composing the logic circuit or for each signal path of the logic circuit,
wherein the simulation is performed to a block including at least one of the cells, and
a delay value varying dependent on a layout direction of the cell included in the block is used as the delay value in the delay library.

2. The semiconductor integrated circuit design method of claim 1, wherein
a delay value of a delay caused in the block due to a physical factor in exposure within a unit exposure region of the block in a case where the block is formed on a wafer is used as the delay value varying dependent on the layout direction of the cell.

3. The semiconductor integrated circuit design method of claim 1, wherein
the delay library includes a delay value dependent on an exposure apparatus used for the exposure.

4. A semiconductor integrated circuit design method comprising the steps of:
creating a delay library that introduces, into delay values calculated for each kind of a plurality of cells composing a logic circuit or for each signal path of the logic signal, delay values varying dependent on layout directions of the cells;
creating a net list by extracting a layout parameter from layout data of a semiconductor integrated circuit using the logic circuit;
extracting a net along one signal path from the thus created net list;
detecting a layout direction of a cell included in the extracted net; and
calculating a delay value of the cell of which layout direction is detected by referencing a delay value in the delay library which corresponds to that of the cell of which layout direction is detected.

5. A semiconductor integrated circuit design support system for simulating a delay of a logic circuit based on delay values which are stored in a delay library and which are calculated for each kind of a plurality of cells composing the logic circuit or for each signal path of the logic circuit, comprising:
a first memory section which reads from the delay library and holds a delay value that introduces a variation amount varying dependent on each layout direction of the cells; and
a second memory section which performs simulation to a block including at least one of the cells, a semiconductor chip region that includes a plurality of blocks each including at least one of the cells, and a unit exposure region that includes a plurality of semiconductor chip regions each including at least one of the blocks,
wherein in layout information of the cells, layout directions of the cells are relayed from the blocks to the semiconductor chip regions and from the semiconductor chip regions to the unit exposure region in hierarchic transition.

6. The semiconductor integrated circuit design support system of claim 5, wherein
the delay library includes a delay value dependent on an exposure apparatus used for exposure.

7. A semiconductor integrated circuit design support system for simulating a delay of a logic circuit based on delay values which are stored in a delay library and which are calculated for each kind of a plurality of cells composing the logic circuit or for each signal path of the logic circuit, comprising:
a first memory section which reads from the delay library and holds a delay value that introduces a variation amount varying dependent on each layout direction of the cells; and
a second memory section which performs simulation to a block including at least one of the cells, a semiconductor chip region that includes a plurality of blocks each including at least one of the cells, and a unit exposure region that includes a plurality of semiconductor chip regions each including at least one of the blocks,
wherein in a net list of the cells, layout directions of the cells are relayed from the blocks to the semiconductor chip regions and from the semiconductor chip regions to the unit exposure region in hierarchic transition.

8. The semiconductor integrated circuit design support system of claim 7, wherein
the delay library includes a delay value dependent on an exposure apparatus used for exposure.

9. A delay library in which delay values that are calculated for each kind of a plurality of cells composing a logic circuit or for each signal path of the logic circuit are stored and which is used in a semiconductor integrated circuit design support system for simulating a delay of the logic circuit, and
the delay values are stored on a per layout direction basis of the cells and on a per exposure apparatus basis which is used for exposure.

10. The delay library of claim 9, wherein
one of the plurality of cells is set as a representative cell, first delay values in each of a plurality of layout directions in each of a plurality of exposure apparatuses of the representative cell are calculated, and delay characteristic variation coefficients of the representative cell are determined from the calculated first delay values,
a second delay value in one layout direction to be a standard in one exposure apparatus to be a standard is calculated for each of the cells, and
the delay values are determined by multiplying the calculated second delay values by the delay characteristic variation coefficients.
